(19) United States
(12) Patent Application Publication
(10) Pub. No.: US 2021/0299515 A1
(43) Pub. Date: Sep. 30, 2021

(54) COMPUTER AUTOMATIC GOLF SWINGING FORM TRAINING METHOD

(71) Applicant: Premtek International Inc., Hsinchu (TW)

(72) Inventor: Yu-Min Ho, Hsinchu (TW)

(21) Appl. No.: 16/887,430

(22) Filed: May 29, 2020

(30) Foreign Application Priority Data
Mar. 25, 2020 (TW) 109110006

(51) Int. Cl. A63B 24/00; A63B 71/06; A63B 69/36

(52) U.S. Cl. CPC A63B 24/0006; A63B 71/0622; A63B 69/3623; A63B 2220/05; A63B 2102/32; A63B 2220/805; A63B 2220/806; A63B 2071/0694; A63B 2024/0015; A63B 2220/803

(57) ABSTRACT

The invention discloses a computer automatic golf swinging form training method, which uses a computer to automatic analyzing a golf swinging form of a golf trainee, comprising: (A) a step of capturing a golf trainee video using an electrical motion capture sensor and/or an optical image capture sensor to capture a golf trainee dynamic swinging form video; (B) a step of retrieving golf trainee form frame; (C) a step of retrieving reference golfer form frame using a processor to automatically retrieve, from the memory, a reference golfer form frame; and (D) a step of automatic comparing frame and providing comparing result automatically comparing the golf trainee form frame and the reference golfer form frame.

### FIELD OF THE INVENTION

The present invention relates to a golf swinging form training method, and more particularly relates to a computer automatic golf swinging form training method that uses a computer to automatically analyze a golf swinging form of a golf trainee.

### BACKGROUND OF THE INVENTION

For a golf trainee to advance his/her golf swinging skill, in addition to spending expensive money by hiring personal golf trainer, there is another efficient learning way of repeatedly watching a demonstration golf swinging video of famous golfers. By repeatedly watching the video, the golf trainee can learn relative positions and time sequence regarding golf's body and limbs from a golf swinging of famous golfers.

However, while the train is performed without an accompanying golf trainer, the golf trainee could only observe by his/her own the appearance of the famous golfer's golf swinging form shown in the video, but the golf trainee could hardly comprehend whether his/her imitating golf swinging form is correct or not. In other words, a golf trainee, who learns a professional golf swing form by only watching video by his own, is difficult to profoundly comprehend not only the essence and secrets of swinging speed, but also the difference of limb and body positions and time sequence between himself/herself and the famous golfer. As a result, the golf trainee cannot realize his/her mistakes in golf swinging learning to cause: a failure golf shot, a wrong direction golf shot, a short distance golf shot, and even a golf injury caused by repeatedly wrong golf swinging form, to unfortunately let the golf trainee quits from learning the golf swinging skill.

### SUMMARY OF THE INVENTION

Therefore, one objective of the present invention is to provide a golf swinging form training method, which uses a computer to automatically analyze a golf swinging form of a golf trainee. Thus, the golf trainee can clearly recognize differences in trunk position-angle, limbs position-angle and swinging sequence between himself/herself and a famous golfer. Accordingly, the golf trainee is able to immediately realize his/her golf swinging mistakes thereby correcting the golf swinging forms and the body posture in time to perfect the golf skill.

In order to achieve the above objective, the present invention provides a computer automatic golf swinging form training method, which uses a computer to automatic analyzing a golf swinging form of a golf trainee, the computer automatic golf swinging form training method comprising: (A) a step of capturing a golf trainee video, which uses an electrical motion capture sensor and/or an optical image capture sensor to capture a golf trainee dynamic swinging form video which is recorded in a period while the golf trainee is in performance of golf swinging, wherein the golf trainee dynamic swinging form video comprises golf trainee limbs information and/or golf trainee trunk information and/or golf trainee golf club information and/or golf trainee club head information, and the golf trainee dynamic swinging form video is stored to a memory, wherein the golf trainee dynamic swinging form video comprises a plurality of golf trainee intermediate form frames; (B) a step of retrieving golf trainee form frame, which automatically retrieves a golf trainee form frame from the golf trainee intermediate form frames according to golf trainee position-angle relation information, the golf trainee position-angle relation information comprises golf trainee limbs position-angle information and/or golf trainee trunk position-angle information and/or golf trainee golf club position-angle information and/or golf trainee club head position-angle information and/or golf trainee position-angle combination information which is combination information of the above information; (C) a step of retrieving reference golfer form frame, which uses a processor to automatically retrieve, from the memory, a reference golfer form frame comprising reference golfer position-angle relation information, the reference golfer position-angle relation information comprising reference golfer limbs position-angle information and/or reference golfer trunk position-angle information and/or reference golfer golf club position-angle information and/or reference golfer club head position-angle information and/or reference golfer position-angle combination information which is combination information of the above information, wherein the reference golfer limbs position-angle information, the reference golfer trunk position-angle information, the reference golfer golf club position-angle information, the reference golfer club head position-angle information, and the reference golfer position-angle combination information respectively correspond to the golf trainee limbs position-angle information, the golf trainee trunk position-angle information, the golf trainee golf club position-angle information, the golf trainee club head position-angle information, and the golf trainee position-angle combination information; and (D) a step of automatic comparing frame and providing comparing result, which automatically compares the golf trainee form frame and the reference golfer form frame in terms of a limbs position-angle information comparison and/or a trunk position-angle information comparison and/or a golf club position-angle information comparison and/or a club head position-angle information comparison and/or a position-angle combination information comparison, and automatically generates a form advising information regarding the golf trainee limbs position-angle information and/or the golf trainee trunk position-angle information and/or the golf trainee golf club position-angle information and/or the golf trainee club head position-angle information and/or the golf trainee position-angle combination information.

In one embodiment of the computer automatic golf swinging form training method, in the step of retrieving reference golfer form frame, the reference golfer form frame is retrieved together with one or more reference golfer form adjacent front frames, which is/are front adjacent to the reference golfer form frame, and/or together with one or more reference golfer form adjacent back frames, which is/are back adjacent to the reference golfer form frame such that a plurality of reference golfer form frames are formed based on the reference golfer form frame, and the plurality of reference golfer form frames are overlapped to display on a monitor in order to compare with the golf trainee form frame in the step of automatic comparing frame and providing comparing result.

In one embodiment of the computer automatic golf swinging form training method, in the step of retrieving golf trainee form frame, the golf trainee form frame is retrieved together with one or more golf trainee form adjacent front frames, which is/are front adjacent to the golf trainee form frame, and/or together with one or more golf trainee form adjacent back frames, which is/are back adjacent to the golf trainee form frame such that a plurality of golf trainee form frames are formed based on the golf trainee form frame, and the plurality of golf trainee form frames are compared with the plurality of reference golfer form frames in the step of automatic comparing frame and providing comparing result.

In one embodiment of the computer automatic golf swinging form training method, the golf trainee dynamic swinging form video, which is recorded in the period while the golf trainee is in performance of golf swinging, in the step of capturing a golf trainee video, is uploaded to the memory via a network connection, wherein the golf trainee dynamic swinging form video comprises the golf trainee limbs information and/or the golf trainee trunk information and/or the golf trainee golf club information and/or the golf trainee club head information.

In one embodiment of the computer automatic golf swinging form training method, in the step of automatic comparing frame and providing comparing result, the processor performs a scaling-up or scaling-down operation on the golf trainee form frame to resize a golf trainee limbs image or a golf trainee trunk image to enable a golf trainee image in the golf trainee form frame to physically match with a reference golfer image of the reference golfer form frame in order to perform an image overlapping comparison between the golf trainee form frame and the reference golfer form frame, or the processor performs a scaling-up or scaling-down operation on the reference golfer form frame to resize a reference golfer limbs image or a reference golfer trunk image to enable a reference golfer image in the reference golfer form frame to physically match with a golf trainee image of the golf trainee form frame in order to perform an image overlapping comparison between the reference golfer form frame and the golf trainee form frame.

The computer automatic golf swinging form training method of the present invention has the technical effects as follows. The golf trainee is able to recognize differences in trunk position-angle, limbs position-angle, and golf club holding angle and swinging speed between the golf trainee and the reference golfer to thus improve his/her time sequence and body/limb position in golf swinging. Moreover, the present invention is able to automatically producing an advice for the golf trainee to make the golf trainee immediately correcting the golf swinging form to improve his/her own golf swinging skill. Therefore, the golf trainee can maintain a correct golf swinging form together with an excellent swinging rhythm in a stable way. In other words, the golf trainee can perform a well repeatable ideal golf swinging form.

### BRIEF DESCRIPTION OF THE DRAWINGS

FIG. 1 is a flow chart illustrating a computer automatic golf swinging form training method according to one embodiment of the present invention;

FIG. 2 is a block diagram illustrating required equipments of the computer automatic golf swinging form training method according to the embodiment of the present invention;

FIG. 3 is a schematic diagram illustrating a plurality of golf trainee intermediate form frames and a plurality of reference golfer intermediate form frames retrieved by the computer automatic golf swinging form training method according to the embodiment of the present invention;

FIG. 4 is a schematic diagram illustrating a scaling-up or scaling-down operation performed, in a triangle fixed point comparison manner, on a reference golfer form frame of address position based on a golf trainee form frame of address position in the computer automatic golf swinging form training method according to one embodiment of the present invention; and

FIG. 5 is a schematic diagram illustrating an images overlapping comparison between a plurality of golf trainee intermediate form frames and a plurality of reference golfer intermediate form frames performed in the computer automatic golf swinging form training method according to one embodiment of the present invention.

### DETAILED DESCRIPTION OF THE PREFERRED EMBODIMENTS

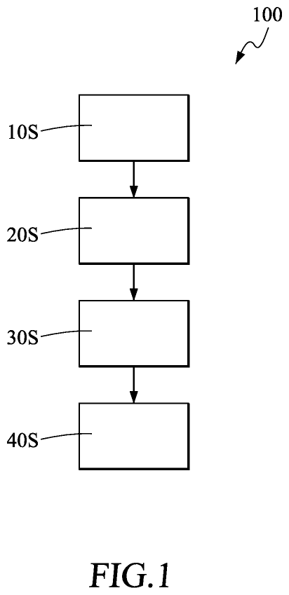

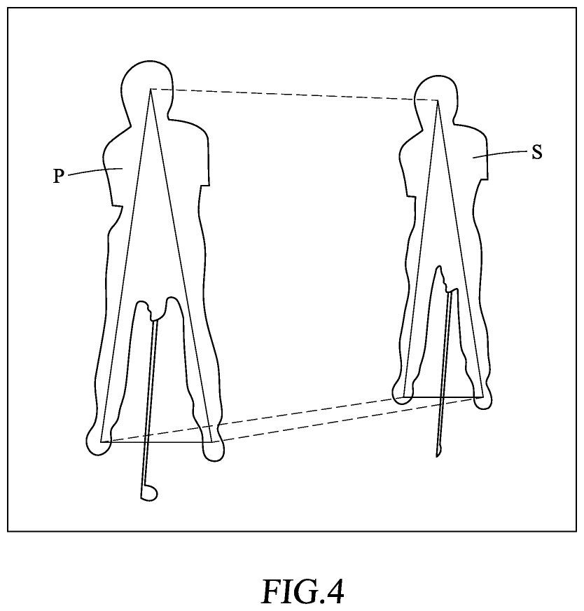

The preferred embodiments of the present invention are described in detail with reference to FIGS. 1 to 5. The description is used for explaining the embodiments of the present invention only, but not for limiting the scope of the claims.

As shown in FIG. 1, in a computer automatic golf swinging form training method 100 according to one embodiment of the present invention, a computer is used to automatic analyzing a golf swinging form of a golf trainee. Moreover, the computer automatic golf swinging form training method 100 comprises: a step (A) with reference numeral 10S, a step (B) with reference numeral 20S, a step (C) with reference numeral 30S and a step (D) with reference numeral 40S. The specific contents of the steps are described in detail as follows.

As shown in FIGS. 1 to 3, the step (A) 10S, which is a step of capturing a golf trainee video, applies an electrical motion capture sensor and/or an optical image capture sensor to capture a golf trainee dynamic swinging form video SA in relation to golf trainee limbs information and/or golf trainee trunk information and/or golf trainee golf club information and/or golf trainee club head information while the golf trainee S is in performance of golf swinging. Specifically, the golf trainee dynamic swinging form video SA comprises a plurality of golf trainee intermediate form frames SP1, SP2, SP3, SP4, SP5, SP6, SP7, and SP8, and the golf trainee dynamic swinging form video SA is stored to a memory D.

Specifically, as shown in FIGS. 1 to 3, in the computer automatic golf swinging form training method 100 according to one embodiment of the present invention, in the step (A) 10S, the golf trainee dynamic swinging form video SA, which comprises the golf trainee limbs information and/or the golf trainee trunk information and/or the golf trainee golf club information and/or the golf trainee club head information and is recorded in the period while the golf trainee is in performance of golf swinging, is uploaded to the memory D via a network connection.

In detail, as shown in FIGS. 1 to 3, the step (A) 10S uses a computational processing equipment C, which has a processor and is connected to the electrical motion capture sensor and/or the optical image capture sensor, to store the golf trainee dynamic swinging form video SA, which is recorded in a period while the golf trainee S (i.e., a golf student or a golf player) is in performance of golf swinging, to the memory D, wherein the computational processing equipment C automatically recognizes the golf trainee trunk/limbs position in the golf trainee dynamic swinging form video SA, or detects an image dimension for the golf trainee S in the golf trainee dynamic swinging form video SA. Specifically, the computer automatic golf swinging form training method 100 according to the present invention can be implemented by the following methods or equipments. For example, a high speed camera R, which is one kind of the optical image capture sensors, records the golf trainee dynamic swinging form video SA, wherein the high speed camera R is electrically connected to a graphics processing unit (GPU) G. The graphics processing unit G performs an image process on the golf trainee dynamic swinging form video SA, and the processed golf trainee dynamic swinging form video SA is displayed by a monitor M.

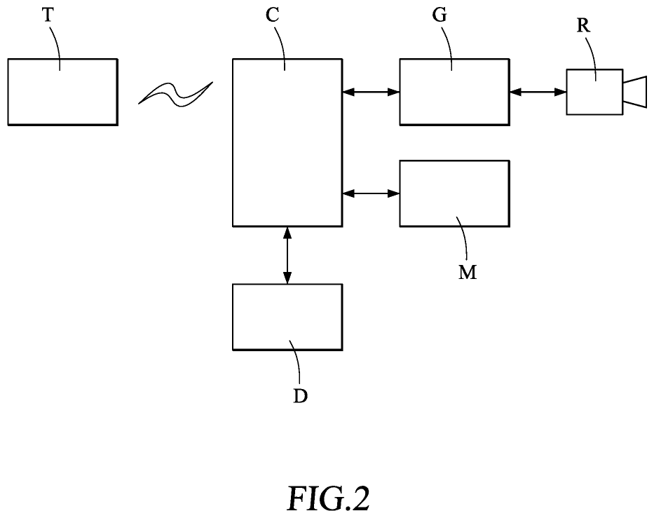

As shown in FIG. 2, the computational processing equipment C is electrically connected to the graphics processing unit G to receive the processed golf trainee dynamic swinging form video SA and store the received golf trainee dynamic swinging form video SA to the memory D. It is noted that the present invention is not limited to the above embodiments. The computational processing equipment C can perform a further process on the golf trainee dynamic swinging form video SA transmitted from the graphics processing unit G, and then transmit the golf trainee dynamic swinging form video SA to the monitor M for inspection by the golf trainee S. Moreover, the computational processing equipment C can be further electrically connected to a data memory T for a data/information transmission, wherein the data memory T can be a solid-state drive (SSD), which is connected to the computational processing equipment C, or the electrical connection between the computational processing equipment C, and the data memory T can be a wireless communication connection of Wi-Fi or Bluetooth.

As shown in FIGS. 1 to 3, in the step (B) 20S, it is a step of retrieving golf trainee form frame. The step (B) 20S automatically retrieves a golf trainee form frame from the golf trainee intermediate form frames SP1, SP2, SP3, SP4, SP5, SP6, SP7, and SP8 according to golf trainee position-angle relation information. The golf trainee position-angle relation information comprises golf trainee limbs position-angle information and/or golf trainee trunk position-angle information and/or golf trainee golf club position-angle information and/or golf trainee club head position-angle information and/or golf trainee position-angle combination information which is combination information of the above information.

Specifically, as shown in FIGS. 1, 3, and 5, in the step (B) 20S, the computational processing equipment C takes, from the memory D, the golf trainee dynamic swinging form video SA, and determines the golf trainee intermediate form frames SP1, SP2, SP3, SP4, SP5, SP6, SP7, and SP8 from the golf trainee dynamic swinging form video SA. It is noted that the eight golf trainee intermediate form frames disclosed in the present invention is merely an example for explaining the embodiments, and in practical implementation, the number of the golf trainee intermediate form frames is not limited to this. For example, the number of the golf trainee intermediate form frames can be five, six, seven, nine, or ten.

In detail, as shown in FIGS. 1, 3, and 4, in the step (B) 20S, the golf trainee intermediate form frames are selected from the golf trainee form frame of address position SP1, the golf trainee form frame of back-swing middle position SP2, the golf trainee form frame of back-swing top position SP3, the golf trainee form frame of down-swing starting position SP4, the golf trainee form frame of down-swing middle position SP5, the golf trainee form frame of hit-ball position SP6, the golf trainee form frame of close-swing position SP7, and the golf trainee form frame of close-swing completion position SP8. Moreover, the computational processing equipment C recognizes a background image, the golf trainee trunk position, and the golf trainee limbs position in the golf trainee form frame of address position SP1 to detect a golf trainee's head and feet position with respect to the golf trainee form frame of address position SP1.

Furthermore, as shown in FIGS. 1 to 5, in the step (B) 20S, the golf trainee dynamic swinging form video SA recorded by the high speed camera R could comprises a golf trainee golf club image or a golf trainee club head image. Accordingly, the present invention can provide advising information regarding a golf club position-angle for the golf trainee S to focus on the golf club swinging form of the golf trainee S in performance of golf swinging such that the golf trainee S can further improve his/her own golf swinging form.

As shown in FIGS. 1 to 4, the step (C) 30S, which is a step of retrieving reference golfer form frame, applies the processor of the computational processing equipment C to automatically retrieve, from the memory D, a reference golfer form frames PP1, PP2, PP3, PP4, PP5, PP6, PP7, and PP8. Each reference golfer form frame comprises reference golfer position-angle relation information. The reference golfer position-angle relation information comprises reference golfer limbs position-angle information and/or reference golfer trunk position-angle information and/or reference golfer golf club position-angle information and/or reference golfer club head position-angle information and/or reference golfer position-angle combination information which is combination information of the above information, wherein the reference golfer limbs position-angle information, the reference golfer trunk position-angle information, the reference golfer golf club position-angle information, the reference golfer club head position-angle information, and the reference golfer position-angle combination information respectively correspond to the golf trainee limbs position-angle information, the golf trainee trunk position-angle information, the golf trainee golf club position-angle information, the golf trainee club head position-angle information, and the golf trainee position-angle combination information.

As shown in FIGS. 1 to 4, in the computer automatic golf swinging form training method 100 according to one embodiment of the present invention, in the step of retrieving reference golfer form frame, the reference golfer form frame is retrieved together with one or more reference golfer form adjacent front frames, which is/are front adjacent to the reference golfer form frame, and/or together with one or more reference golfer form adjacent back frames, which is/are back adjacent to the reference golfer form frame such that a plurality of reference golfer form frames are formed based on the reference golfer form frame, and the plurality of reference golfer form frames are overlapped to display on a monitor M in order to compare with the golf trainee form frame.

As shown in FIGS. 1 to 4, in the computer automatic golf swinging form training method 100 according to one embodiment of the present invention, in the step of retrieving reference golfer form frame, the golf trainee form frame is retrieved together with one or more golf trainee form adjacent front frames, which is/are front adjacent to the golf trainee form frame, and/or together with one or more golf trainee form adjacent back frames, which is/are back adjacent to the golf trainee form frame such that a plurality of golf trainee form frames are formed based on the golf trainee form frame, and the plurality of golf trainee form frames are compared with the plurality of reference golfer form frames. For example, in the step (B) 20S, the golf trainee form frame is retrieved together with three golf trainee form adjacent front frames and together with three golf trainee form adjacent back frames to form seven form frames based on the golf trainee form frame. Furthermore, in the step (C) 30S, the reference golfer form frame is retrieved together with three reference golfer form adjacent front frames and together with three reference golfer form adjacent back frames to form seven form frames based on the reference golfer form frame.

In other words, as shown in FIGS. 2 to 5, the computational processing equipment C retrieves, from the memory D that stores the reference golfer dynamic swinging form video PA, the reference golfer dynamic swinging form video PA which is recorded in a period while the reference golfer P (i.e., a famous golf professional or a golf trainer) is in performance of golf swinging. According to the embodiments disclosed in the specification and drawings of the present invention, the reference golfer dynamic swinging form video PA comprises the plurality of reference golfer intermediate form frames PP1, PP2, PP3, PP4, PP5, PP6, PP7, and PP8. It is noted that the number of eight for the reference golfer form frames disclosed in the present invention is merely an example for explaining the embodiments. In actual implementation, the number of the reference golfer intermediate form frames is not limited to this, and for example, the number of the golf trainee intermediate form frames can be five, six, seven, nine, or ten.

In the embodiment of the present invention, as shown in FIGS. 1, 3, and 4, in the step (C) 30S, the plurality of reference golfer intermediate form frames PP1, PP2, PP3, PP4, PP5, PP6, PP7, and PP8 are selected from the reference golfer form frame of address position PP1, the reference golfer form frame of back-swing middle position PP2, the reference golfer form frame of back-swing top position PP3, the reference golfer form frame of down-swing starting position PP4, the reference golfer form frame of down-swing middle position PP5, the reference golfer form frame of hit-ball position PP6, the reference golfer form frame of close-swing position PP7, and the reference golfer form frame of close-swing completion position PP8. Moreover, the computational processing equipment C recognizes a background image, the reference golfer trunk position, and the reference golfer limbs position in the reference golfer form frame in address position PP1 to detect a reference golfer's head and feet position with respect to the reference golfer form frame in address position PP1.

Specifically, in the step (C) 30S, the reference golfer dynamic swinging form video PA could further contain the reference golfer golf club image or the reference golfer club head image. In this case, the present invention can provide advising information regarding the golf club position-angle for the golf trainee S to focus on the golf club swinging form of the reference golfer P in performance of golf swinging such that the golf trainee S can further improve his/her own golf swinging form.

As shown in FIGS. 1, 3, and 5, the step (D) 40S, a step of automatic comparing frame and providing comparing result, automatically compares the golf trainee form frame and the reference golfer form frame in terms of a limbs position-angle information comparison and/or a trunk position-angle information comparison and/or a golf club position-angle information comparison and/or a club head position-angle information comparison and/or a position-angle combination information comparison. Therefore, the step (D) 40S automatically generates form advising information regarding the golf trainee limbs position-angle information and/or the golf trainee trunk position-angle information and/or the golf trainee golf club position-angle information and/or the golf trainee club head position-angle information and/or the golf trainee position-angle combination information.

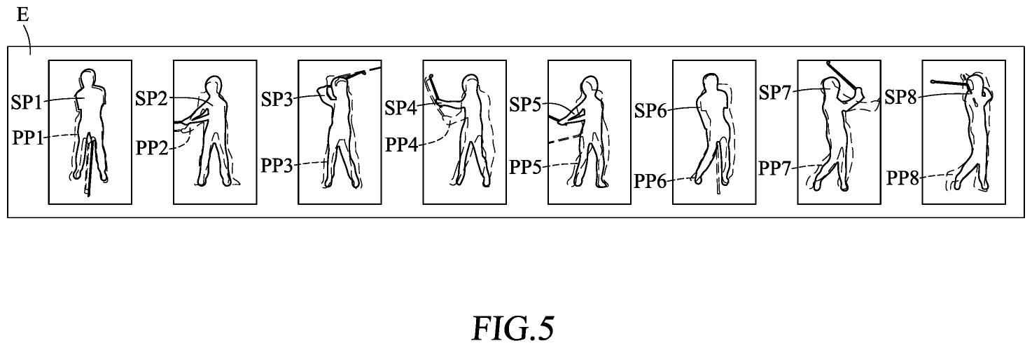

As shown in FIG. 5, in the computer automatic golf swinging form training method 100 according to one embodiment of the present invention, in the step (D) 40S, the processor performs a scaling-up or scaling-down operation on the golf trainee form frame to resize a golf trainee limbs image or a golf trainee trunk image to enable a golf trainee image in the golf trainee form frame to physically match with a reference golfer image of the reference golfer form frame in order to perform an image overlapping comparison between the golf trainee form frame and the reference golfer form frame. Alternatively, the processor performs a scaling-up or scaling-down operation on the reference golfer form frame to resize a reference golfer limbs image or a reference golfer trunk image to enable a reference golfer image in the reference golfer form frame to physically match with a golf trainee image of the golf trainee form frame in order to perform an image overlapping comparison between the reference golfer form frame and the golf trainee form frame.

Specifically, as shown in FIGS. 1 to 4, in the step (D) 40S, the present invention uses the computational processing equipment C to perform, in a triangle fixed point comparison manner, the scaling-up or scaling-down operation on the reference golfer form frame of address position PP1 based on the golf trainee form frame of address position SP1 to resize the image such that the reference golfer trunk image in the reference golfer form frame of address position PP1 overlaps with a golf trainee trunk image of the golf trainee form frame of address position SP1. Therefore, in the present invention, the reference golfer images in the other reference golfer form frames PP2, PP3, PP4, PP5, PP6, PP7 and PP8 of the plurality of reference golfer intermediate form frames respectively and sequentially is overlapped with the golf swinging form of the golf trainee images in the other golf trainee form frames SP2, SP3, SP4, SP5, SP6, SP7 and SP8 of the plurality of golf trainee intermediate form frames, wherein the triangle fixed point comparison is used to respectively compare three fixed points of head and two feet in the reference golfer image with that in the golf trainee image.

In other words, the reference golfer image in the reference golfer form frame of back-swing middle position PP2 overlaps with the golf trainee image in the golf trainee form frame of back-swing middle position SP2. The reference golfer image in the reference golfer form frame of back-swing top position PP3 overlaps with the golf trainee image in the golf trainee form frame of back-swing top position SP3. The reference golfer image in the reference golfer form frame of down-swing starting position PP4 overlaps with the golf trainee image in the golf trainee form frame of down-swing starting position SP4. The reference golfer image in the reference golfer form frame of down-swing middle position PP5 overlaps with the golf trainee image in the golf trainee form frame of down-swing middle position SP5. The reference golfer image in the reference golfer form frame of hit-ball position PP6 overlaps with the golf trainee image in the golf trainee form frame of hit-ball position SP6. The reference golfer image in the reference golfer form frame of close-swing position PP7 overlaps with the golf trainee image in the golf trainee form frame of close-swing position SP7. The reference golfer image in the reference golfer form frame of close-swing completion position PP8 overlaps with the golf trainee image in the golf trainee form frame of close-swing completion position SP8.

Furthermore, in the step (D) 40S, as shown in FIGS. 1 and 2, the angle of the reference golfer intermediate form frames PP1, PP2, PP3, PP4, PP5, PP6, PP7, and PP8 can be adjusted by further transforming the reference golfer dynamic swinging form video PA from 2D to 3D such that limbs position-angle information comparison is performed between the limbs image in the reference golfer intermediate form frames PP1, PP2, PP3, PP4, PP5, PP6, PP7, and PP8 and the limbs image in the golf trainee intermediate form frames SP1, SP2, SP3, SP4, SP5, SP6, SP7, and SP8.

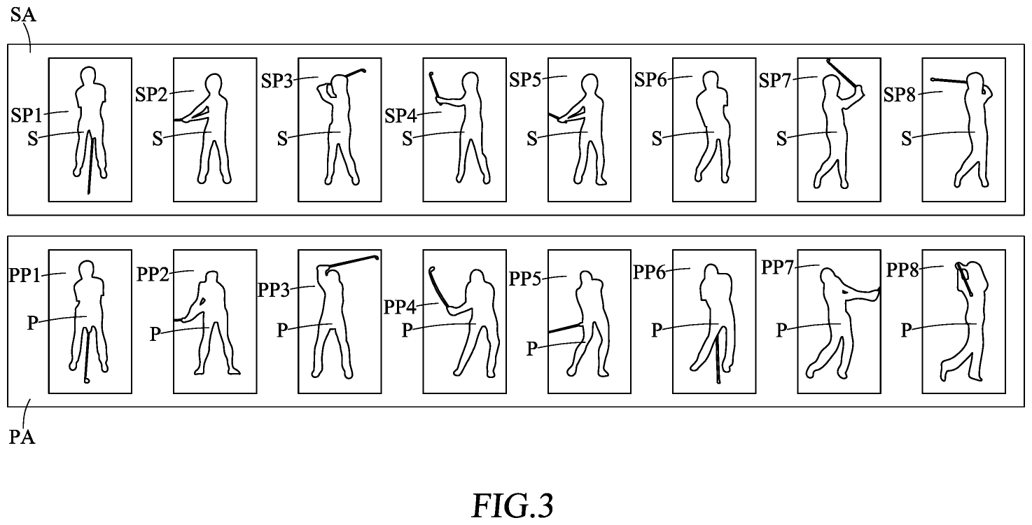

As shown in FIGS. 3 to 5, in the step (D) 40S, the limbs position-angle information comparison between the golf trainee limbs information of the plurality of golf trainee intermediate form frames and the reference golfer limbs information of the plurality of the resized reference golfer intermediate form frames is performed in a manner that the reference golfer form frame of address position PP1 overlaps with the golf trainee form frame of address position SP1 and the other reference golfer form frames PP2, PP3, PP4, PP5, PP6, PP7 and PP8 of the plurality of reference golfer intermediate form frames respectively and sequentially overlap with the other golf trainee form frames SP2, SP3, SP4, SP5, SP6, SP7 and SP8 of the plurality of golf trainee intermediate form frames of the golf swinging form, thereby obtaining image differences regarding the golf swinging form between the golf trainee S and the reference golfer P in performance of golf swinging.

In detail, as shown in FIGS. 3 to 5, in an overlapping picture E according to the present invention, the other golf trainee position form frames of the plurality of golf trainee intermediate form frames respectively and sequentially overlap with the other golf trainee form frames of the plurality of golf trainee intermediate form frames in the golf swinging form. Specifically, the reference golfer form frame of back-swing middle position PP2 overlaps with the golf trainee form frame of back-swing middle position SP2 for the limbs position-angle information comparison; the reference golfer form frame of back-swing top position PP3 overlaps with the golf trainee form frame of back-swing top position SP3 for the limbs position-angle information comparison; the reference golfer form frame of down-swing starting position PP4 overlaps with the golf trainee form frame of down-swing starting position SP4 for the limbs position-angle information comparison; the reference golfer form frame of down-swing middle position PP5 overlaps with the golf trainee form frame of down-swing middle position SP5 for the limbs position-angle information comparison; the reference golfer form frame of hit-ball position PP6 overlaps with the golf trainee form frame of hit-ball position SP6 for the limbs position-angle information comparison; the reference golfer form frame of close-swing position PP7 overlaps with the golf trainee form frame of close-swing position SP7 for the limbs position-angle information comparison; the reference golfer form frame of close-swing completion position PP8 overlaps with the golf trainee form frame of close-swing completion position SP8 for the limbs position-angle information comparison.

Furthermore, in the step (D) 40S, the form advising information includes information which is automatically provided to the golf trainee S in term of limbs motion correction of golf swinging. In detail, the present invention takes the reference golfer P as a comparative model, retrieves the reference golfer P trunk position-angle, limbs position-angle and the golf club grabbing angle, and collects and analyzes as well the data regarding the golf trainee S trunk position-angle, limbs position-angle and the golf club swinging speed for the operation while the golf trainee S is in performance of golf swinging. Therefore, the present invention performs the image overlapping comparisons between the golf trainee intermediate form frames SP1, SP2, SP3, SP4, SP5, SP6, SP7, and SP8 and the reference golfer intermediate form frames PP1, PP2, PP3, PP4, PP5, PP6, PP7, and PP8 to obtain image differences regarding the golf swinging form between the golf trainee S and the reference golfer P such that the present invention provides the advising information regarding the golf swinging correction and the swinging speed adjustment to the golf trainee S.

As the above embodiments, in the computer automatic golf swinging form training method 100 according to the embodiment of the present invention, the image overlapping comparison between the golf trainee intermediate form frames SP1, SP2, SP3, SP4, SP5, SP6, SP7, and SP8 and the reference golfer intermediate form frames PP1, PP2, PP3, PP4, PP5, PP6, PP7, and PP8 is performed such that the golf trainee limbs image overlaps with the reference golfer limbs image in the images overlapping comparison manner. Therefore the golf trainee S clearly recognizes the differences in trunk position-angle, limbs position-angle, the golf club grabbing angle and the swinging speed between the golf trainee S and the reference golfer P thereby improving his/her golf swinging time sequence and body relative positions in golf swinging. Moreover, in a condition that the reference golfer P golf swinging is taken as the comparative model, the present invention collects the data regarding the golf trainee S trunk position-angle, limbs position-angle and the golf club swinging speed while the golf trainee S is in performance of golf swinging, and analyzes the differences in the trunk relative positions and the golf swinging forms between the golf trainee S and the reference golfer P such that the form advising information is automatically generated, and the golf trainee S immediately corrects the trunk relative positions and the golf swinging form. Therefore, the present invention achieve an object to enable the golf trainee S to maintain a correct golf swinging form together with an excellent swinging rhythm in a stable way.

The above description is merely the explanation of the preferred embodiment of the present invention. The ordinary person skilled in the art can apply other adjustments according to the claims below and the above description. However, the adjustments still belong to the technical concept of the present invention and fall into the claims of the present invention.

What is claimed is:

1. A computer automatic golf swinging form training method, which uses a computer to automatic analyzing a golf swinging form of a golf trainee, the computer automatic golf swinging form training method comprising:
(A) a step of capturing a golf trainee video, which uses an electrical motion capture sensor and/or an optical image capture sensor to capture a golf trainee dynamic swinging form video which is recorded in a period while the golf trainee is in performance of golf swinging, wherein the golf trainee dynamic swinging form video comprises golf trainee limbs information and/or golf trainee trunk information and/or golf trainee golf club information and/or golf trainee club head information, and the golf trainee dynamic swinging form video is stored to a memory, wherein the golf trainee dynamic swinging form video comprises a plurality of golf trainee intermediate form frames;
(B) a step of retrieving golf trainee form frame, which automatically retrieves a golf trainee form frame from the golf trainee intermediate form frames according to golf trainee position-angle relation information, the golf trainee position-angle relation information comprises golf trainee limbs position-angle information and/or golf trainee trunk position-angle information and/or golf trainee golf club position-angle information and/or golf trainee club head position-angle information and/or golf trainee position-angle combination information which is combination information of the above information;
(C) a step of retrieving reference golfer form frame, which uses a processor to automatically retrieve, from the memory, a reference golfer form frame comprising reference golfer position-angle relation information, the reference golfer position-angle relation information comprising reference golfer limbs position-angle information and/or reference golfer trunk position-angle information and/or reference golfer golf club position-angle information and/or reference golfer club head position-angle information and/or reference golfer position-angle combination information which is combination information of the above information, wherein the reference golfer limbs position-angle information, the reference golfer trunk position-angle information, the reference golfer golf club position-angle information, the reference golfer club head position-angle information, and the reference golfer position-angle combination information respectively correspond to the golf trainee limbs position-angle information, the golf trainee trunk position-angle information, the golf trainee golf club position-angle information, the golf trainee club head position-angle information, and the golf trainee position-angle combination information; and
(D) a step of automatic comparing frame and providing comparing result, which automatically compares the golf trainee form frame and the reference golfer form frame in terms of a limbs position-angle information comparison and/or a trunk position-angle information comparison and/or a golf club position-angle information comparison and/or a club head position-angle information comparison and/or a position-angle combination information comparison, and automatically generates a form advising information regarding the golf trainee limbs position-angle information and/or the golf trainee trunk position-angle information and/or the golf trainee golf club position-angle information and/or the golf trainee club head position-angle information and/or the golf trainee position-angle combination information.

2. The computer automatic golf swinging form training method as claimed in claim 1, wherein in the step of retrieving reference golfer form frame, the reference golfer form frame is retrieved together with one or more reference golfer form adjacent front frames, which is/are front adjacent to the reference golfer form frame, and/or together with one or more reference golfer form adjacent back frames, which is/are back adjacent to the reference golfer form frame such that a plurality of reference golfer form frames are formed based on the reference golfer form frame, and the plurality of reference golfer form frames are overlapped to display on a monitor in order to compare with the golf trainee form frame in the step of automatic comparing frame and providing comparing result.

3. The computer automatic golf swinging form training method as claimed in claim 2, wherein in the step of retrieving golf trainee form frame, the golf trainee form frame is retrieved together with one or more golf trainee form adjacent front frames, which is/are front adjacent to the golf trainee form frame, and/or together with one or more golf trainee form adjacent back frames, which is/are back adjacent to the golf trainee form frame such that a plurality of golf trainee form frames are formed based on the golf trainee form frame, and the plurality of golf trainee form frames are compared with the plurality of reference golfer form frames in the step of automatic comparing frame and providing comparing result.

4. The computer automatic golf swinging form training method as claimed in claim 1, wherein the golf trainee dynamic swinging form video, which is recorded in the period while the golf trainee is in performance of golf swinging, in the step of capturing a golf trainee video, is uploaded to the memory via a network connection, wherein the golf trainee dynamic swinging form video comprises the golf trainee limbs information and/or the golf trainee trunk information and/or the golf trainee golf club information and/or the golf trainee club head information.

5. The computer automatic golf swinging form training method as claimed in claim 1, wherein in the step of automatic comparing frame and providing comparing result, the processor performs a scaling-up or scaling-down operation on the golf trainee form frame to resize a golf trainee limbs image or a golf trainee trunk image to enable a golf trainee image in the golf trainee form frame to physically match with a reference golfer image of the reference golfer form frame in order to perform an image overlapping comparison between the golf trainee form frame and the reference golfer form frame, or
the processor performs a scaling-up or scaling-down operation on the reference golfer form frame to resize a reference golfer limbs image or a reference golfer trunk image to enable a reference golfer image in the reference golfer form frame to physically match with a golf trainee image of the golf trainee form frame in order to perform an image overlapping comparison between the reference golfer form frame and the golf trainee form frame.
